(19) United States
(12) Patent Application Publication
(10) Pub. No.: US 2007/0183166 A1
(43) Pub. Date: Aug. 9, 2007

(54) HEADLIGHT MODULE WITH CUT-OFF, FOR A MOTOR VEHICLE

(75) Inventor: Pierre Albou, BOBIGNY Cedex (FR)

Correspondence Address: MATTHEW R. JENKINS, ESQ., 2310 FAR HILLS BUILDING, DAYTON, OH, 45419, US

(73) Assignee: VALEO VISION, BOBIGNY Cedex (FR)

(21) Appl. No.: 11/670,473

(22) Filed: Feb. 2, 2007

(30) Foreign Application Priority Data
Feb. 3, 2006 (FR) 06 01 006

(51) Int. Cl. F21V 7/00

(52) U.S. Cl. 362/514

(57) ABSTRACT

An optical module of a headlight for a motor vehicle, for giving a cut-off beam and comprising a plurality of reflectors, including a reflector which is situated below the horizontal plane that passes through the optical axis and that defines a meridian curve which consists of an elliptical arc; a curve situated in front of the end of the elliptical arc, the front end of this curve being coincident with the second focus of the elliptical arc, or close to the focus; and together with a lens surrounds at least one zone of the lower portion of the convergent lens, or, in the absence of any convergent lens, surrounding the zone through which the rays pass in the plane of the lens.

### BACKGROUND OF THE INVENTION

1. Field of the Invention

This invention relates to an optical module of a headlight for a motor vehicle, for giving a beam with a cut-off, in particular a low or passing beam, and defining an optical axis, the headlight being of the kind which includes at least one reflector and a light source, for example the following:
a reflector of the elliptical type which is situated mainly above the horizontal plane passing through the optical axis, having a first focus which is situated on the optical axis towards the bottom of the headlight and a second focus which is situated further forward on the optical axis;
a deflector, the front edge of which passes through the second focus of the reflector or close thereto;
a light source situated at the first focus of the reflector or in the vicinity of that focus, the light source being arranged to emit light both upwards and downwards; and
a convergent lens which is situated in front of the deflector and which defines a focus which is coincident with the second focus of the reflector or which is close to the second focus.

More particularly, the invention relates, though not exclusively, to a headlight module in which the light source consists of a discharge lamp, also called a xenon lamp.

2. Description of the Related Art

Optical modules, such as headlight modules, are used in vehicles and emit light rays to assist a driver with navigating the vehicle. Light emitted downwards is generally not used in current modules because it can give rise to rising emergent rays which are the cause of dazzling of drivers travelling in the opposite or incoming direction.

As a result of this, the possibilities offered by light sources which emit both upwards and downwards are not being fully exploited. A headlight module giving a cut-off beam, equipped with such a light source that emits both upwards and downwards, with current arrangements which make use of a deflector and a cover, does not therefore offer optimal performance.

There is, therefore, a need to provide an improved module that is capable of emitting light both upwards and downwards that minimizes or eliminates dazzling.

### SUMMARY OF THE INVENTION

The main object of the invention is to provide a headlight module of the kind defined above, the efficiency of which is improved with a view to obtaining a greater light flux than that which is provided by current arrangements with halogen or similar lamps.

The invention provides an optical module of a headlight for a motor vehicle, for giving a cut-off beam, in particular a low beam, defining an optical axis, which comprises at least the following:
either a first reflector and a light source, in particular a reflector of the elliptical type associated with a light source, a cover piece, optionally a deflector, and a convergent lens,
or a reflector with a complex surface associated with a light source, and which further includes:

a second reflector which is situated below the horizontal plane that passes through the optical axis, the second reflector defining a meridian curve which consists of the following:
an elliptical arc, and
a curve situated in front of the end of the elliptical arc, the front end of this curve being coincident with the second focus of the elliptical arc or close to the focus,
together with a lens which surrounds at least one zone of the lower portion of the convergent lens, or, in the absence of any convergent lens, surrounding the zone through which the rays pass in the plane of the lens,
the cross section of the lens, taken through a plane which preferably passes through the optical axis, giving two curves corresponding respectively to the input face and the output face of the lens, the curves themselves corresponding to the cross section of a convergent lens taken through a plane passing through its optical axis.

Preferably, the second reflector is a body of revolution about the optical axis.

The curve situated in front of the end of the elliptical arc is advantageously replaced by a straight segment parallel to the optical axis, and situated in front of the end of the elliptical arc, the front end of the straight segment being coincident with the second focus of the elliptical arc, or close to the focus.

Preferably, the lens according to the invention is annular, and in particular has the form of a sector of revolution about the optical axis.

The optical headlight module for a motor vehicle according to the invention, for giving a cut-off beam, in particular a low beam, defining an optical axis, comprises at least one reflector and a light source, in particular either a reflector of the elliptical type associated with a light source, a cover piece, optionally a deflector, and a lens, or else a reflector with a complex surface associated with a light source.

The module further comprises the following:

a second reflector which is situated below the horizontal plane that passes through the optical axis, this second reflector being a body of revolution about the optical axis and defining a meridian curve which is composed of the following:
an elliptical arc, the first focus of which is coincident with the first focus of the elliptical reflector, the geometric axis of the elliptical arc being inclined on the optical axis so as to be divergent from it in the forward direction, the second focus of the elliptical arc being preferably disposed in front of the first focus of the arc but behind the convergent lens,
and a straight segment which is substantially parallel to the optical axis and which is situated in front of the end of the elliptical arc, with the front end of this straight segment being coincident with the second focus of the elliptical arc, or close to that focus,
and an annular lens which is in the form of a sector of revolution about the optical axis, and which surrounds at least one zone of the lower part of the convergent lens.

The cross section of this annular lens through a plane preferably passes through the optical axis, giving two curves which correspond respectively to the input face and the output face of the lens, these curves themselves corresponding to the cross section of a convergent lens taken through a plane which passes through its optical axis.

The module according to one embodiment of the invention enables a part of the light emitted downwards by the light source to be recuperated so as to contribute to the formation of the cut-off beam, while avoiding the risk of dazzling.

Preferably, the light source is a discharge lamp or a xenon lamp. With a discharge lamp giving a flux of 3000 lumens approximately, the headlight module according to the invention enables a cut-off light beam to be produced of about 1500 lumens.

Generally the light source defines an axis which is coincident with the optical axis of the module.

The annular lens has a flat face that faces outwards and a convex face that faces towards the reflector. The outer face of the annular lens may have vertical ribs for the purpose of enabling the light beam to be spread.

The annular lens may be made of a plastics material, which is preferably formed by molding it onto the main lens, the latter being made generally of glass. The assembly consisting of the main lens and the annular lens then constitutes a single component.

Besides the arrangements set forth above, the invention comprises a certain number of further arrangements, which will be discussed more explicitly below with reference to an example of an embodiment, which will be described with reference to the attached drawings, but which is in no way limiting.

These and other objects and advantages of the invention will be apparent from the following description, the accompanying drawings and the appended claims.

### BRIEF DESCRIPTION OF THE DRAWINGS

FIG. 1 is a diagrammatic cross section taken through a vertical plane passing through the optical axis, and showing a headlight module according to the invention;

FIG. 2 is front view, shown partly cut away, of the headlight module of FIG. 1;

FIG. 3 is a view of the annular lens, in cross section taken on the line III-III in FIG. 1;

FIG. 4 is a pattern of isolux curves obtained with only the lower portion of the module, in the absence of ribs;

FIG. 5 is a pattern of isolux curves obtained only with the upper part of the module;

FIG. 6 is a pattern of isolux curves obtained with only the lower part of the module, with ribs; and

FIG. 7 is another version of FIG. 2.

### DESCRIPTION OF PREFERRED EMBODIMENTS OF THE INVENTION

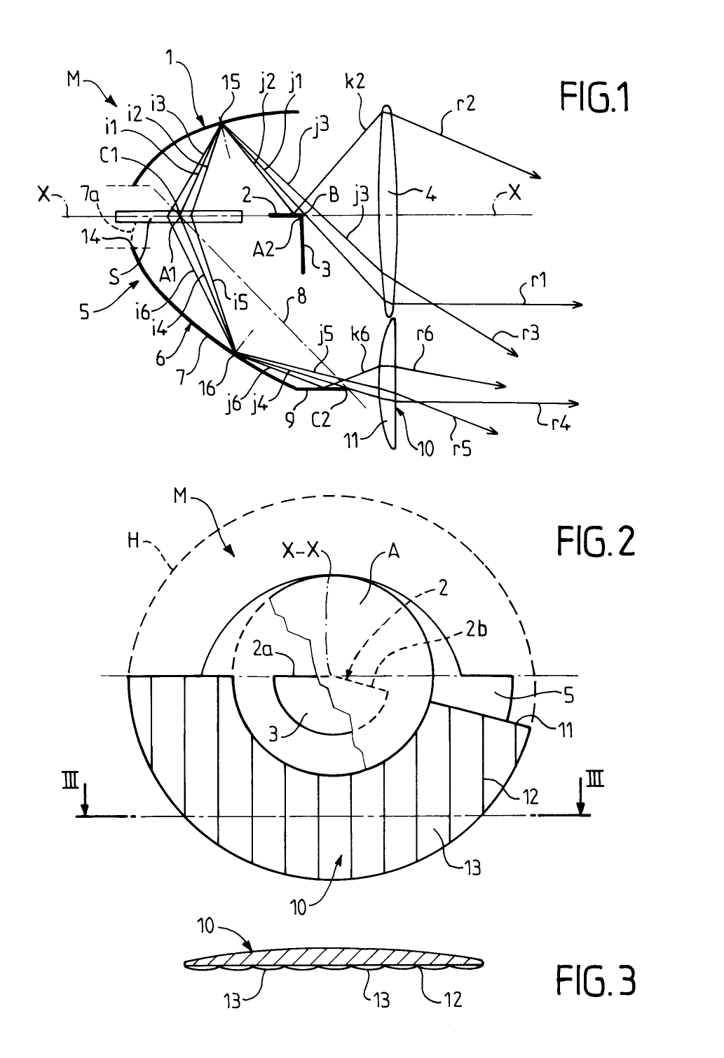

With reference to FIGS. 1 and 2, a module M of a headlight for a motor vehicle can be seen, this module being arranged to give a cut-off beam of the low-beam or passing beam type, this module having an optical axis X-X.

In all of the text of this description and the Claims hereof, the terms front and rear are to be understood to relate to the direction of propagation of the light emitted by the headlight.

The module M includes a reflector 1 of the elliptical type, which is situated above the horizontal plane passing through the optical axis X-X. The expression “of the elliptical type” in all of this text is to be understood to designate a reflector of the elliptical type in the sense in which it is well understood in the field of motor vehicle headlights. The reflector 1 has a first focus A1 which is situated on the optical axis towards the bottom of the headlight, and a second focus A2 which is situated further forward on the optical axis.

The reflector includes a light deflector 2, that is to say a small plate or strip, the top surface of which is reflective. As can be seen in FIG. 2, a portion 2a of the deflector which is situated in line with the optical axis is disposed in the horizontal plane that passes through the said optical axis, while the portion 2b situated to the left of the optical axis is inclined downwards by an angle of 15°. This portion 2b corresponds to the rising portion of the cut-off of the low beam. The front edge of the deflector 2 is situated in a plane which is orthogonal to the optical axis X-X and which passes through the second focus A2 of the reflector or close to it. The deflector 2 extends rearwards towards the reflector 1 over a short distance, which is less than 10 millimeters and is in particular about 7 millimeters.

A light source S, which emits lights both upwards and downwards, is situated at the first focus A1 of the reflector 1. Preferably, the point of maximum emission of the source S is situated at the focus A1. The source S preferably consists of a discharge lamp, the axis of which is coincident with the optical axis X-X. If necessary, the axis of the light source S could be oriented transversely with respect to the optical axis X-X.

A xenon lamp emits about two thirds of its light upwards, and one third downwards. In a modified version, the source S may consist of a halogen lamp, which also emits light both upwards and downwards.

A cover piece 3 extends downwards from a front edge of the deflector 2 in a vertical plane at right angles to the optical axis X-X, over a distance which is sufficiently great to prevent any light from the source S falling directly on a convergent lens 4 which is disposed in front of the deflector.

The convergent lens 4 has a focus B which is coincident with the second focus A2 of the reflector 1. The focus B is situated on the front edge of the deflector 2. The lens 4 has a generally circular contour which is centered on the optical axis X-X, the mean plane of this lens 4 being at right angles to the said axis.

The module M includes a second reflector 5 which is situated below the horizontal plane passing through the optical axis X-X. This second reflector 5 is a body of revolution about the optical axis X-X. The meridian curve 6 of the second reflector 5 includes an elliptical arc 7, a first focus of which is coincident with the first focus A1 of the reflector 1 of the elliptical type; the geometric axis 8 of the elliptical arc 7 is inclined with respect to the optical axis X-X, in such a way as to be divergent from the latter in the direction from the rear towards the front. The second focus C2 of the elliptical arc 7 is situated in front of the first focus C1, but behind the convergent lens 4. This second focus C2 is spaced radially away from the optical axis X-X, by a distance greater than the radius of the circular contour of the lens 4.

The meridian 6 further includes a straight segment 9 which is parallel to the optical axis X-X and which extends forward from the end of the arc 7. The front end of the segment 9 is coincident with the second focus C2 of the elliptical arc 7.

An annular lens 10, in the form of a sector of revolution about the optical axis X-X, surrounds a zone of the lower portion of the convergent lens 4, as can be seen in FIG. 2. The cross section 11 of the annular lens 10, taken through a plane passing through the optical axis, corresponds to two elementary curves which can be referred to, for brevity, by the term “meniscus”, and the focus of which would be situated at the front end of the straight segment 9 and be coincident with the second focus C2 of the elliptical arc 7.

The lens 10 has a solid face which faces towards the front, and a convex face which faces towards the rear.

The straight segment 9, during its revolution about the optical axis X-X, generates a portion of a cylindrical surface, the concave portion of which, facing towards the optical axis, is reflective, as is the concave portion of the elliptical arc 7.

The annular lens 10 constitutes a sector of a crown which surrounds the lower portion of the lens 4, extending from the horizontal plane passing through the optical axis which, to a viewer looking at FIG. 2, lies to the left of the lens 4, and the sector extends up to a plane 11 which passes through the optical axis and which is inclined by 15° downwards from the horizontal.

The main lens 4 is generally made of glass. The annular lens 10 may be made of a plastics material, and may be formed by molding it on the glass. The assembly consisting of the lens 4 and the annular lens 10 is able to constitute a single component. In a modified version, the annular lens 10 may be made of a thermoplastic material, with fastening lugs formed by in situ molding on the edges of the main lens 4. Polysulphone (PPS) or polycarbonate can be cited as possible plastics materials for the annular lens 10.

The elliptical upper lens 1, and the deflector 2, are preferably made of metal so as to withstand high temperatures well. The lower reflector 5 may be made of metal or of a plastics material. The metallic components may be fabricated in pressed steel, bent or curved, or they may be of injection cast aluminum. In particular, the reflector assembly consisting of the reflector 1 of the elliptical type and the lower reflector 5 may be made of metal formed by injection.

Outwardly convex vertical ribs 12, separating cylindrical surfaces 13 having vertical generatrices, are preferably provided. The vertical ribs 12 and surfaces 13 contribute to the spreading of the beam produced by the annular portion 10. The pitch of the ribs 12 may be of the order of 10 millimeters. The cylindrical elements 13 may be disposed on the flat output face of the annulus 10. The term “deposited” is to be understood as being the result of a geometrical projection. The resulting forms are in fact obtained by molding of the outer face in the form of a single piece.

The inner end 7a of the elliptical arc 7 could be liable to pose a problem in the stripping of the inner reflector 5 from its mold. However, because of the presence of a hole 14 which is necessary for mounting the support of the light source S, this problem disappears.

Seen from the front (as in FIG. 2), the lower reflector 5 is wider than the lens 4. The height H of the crown 10 can if desired by completed with an additional function, for example that of a pilot lamp.

Where the elliptical reflector 1 and lower reflector 5 are made as two separate components, the lamp L and deflector 2 can be mechanically assembled together by seaming along the edges of the two components.

The headlight module M works in the following way.

A light ray i1, issuing from a point on the light source S which is coincident with the focus A1 and directed upwards, falls on a point 15 of the reflector surface 1, and is reflected in a ray j1 which passes through the second focus A2 of the reflector 1 on the edge of the deflector 2. The ray j1 is refracted by the lens 4 and leaves parallel to the optical axis X-X in a ray r1.

A ray i2, coming from a point on the source which is situated in front of the focus A1 and which is directed upwards to fall on the point 15, is reflected in the ray j2 and falls on the deflector 2 behind the front edge and behind the focus A2. This ray j2 is reflected by the deflector in a ray k2 which is directed upwards and which gives a downwardly directed ray r2 at the output of the lens 4.

A ray i3, issued from a point on the source S situated behind the focus A1 and directed upwards to fall on the point 15, is reflected in the ray j3 directed downwards, which passes in front of the deflector 2 and leaves the lens 4 in a downwardly directed ray r3.

Accordingly, it will be apparent that the light emitted upwards by the source S gives a beam in which the light rays lie below a cut-off line formed by the image of the edge of the deflector 2 which is given by the lens 4.

The downward light emitted by the source S will now be considered.

A light ray i4 issued from the focus A1 and directed downwards falls at a point 16 of the second reflector 5, and is reflected in a ray j4 which passes through a second focus C2 of the elliptical arc 7. Since the point C2 is also the focus of the cross section of the lens 10, the ray j4 becomes a ray r4 parallel to the optical axis X-X at the output of the lens 10.

A ray i5, coming from a point on the source which is situated in front of the focus A1, falls on the point 16, to be reflected in a downward ray j5 which passes in front of the segment 9 and leaves the lens 10 in a ray r5, which is also directed downwards.

A light ray i6, which is emitted by a point on the light source situated behind the focus A1 and which is directed downwards to fall on the point 16, is reflected in a ray j6 which falls on the reflective cylindrical surface generated by the segment 9, behind the focus C2. This ray j6 is reflected in a ray k6 which is directed upwards. The ray k6 at the output of the lens 10 gives a ray r6 which is directed downwards.

The overall light beam produced by the module M is reinforced by the downwardly directed supplementary light from the light source S.

As a result, we have a headlight module with a discharge lamp and a cut-off, which is highly effective.

The cut-off is produced by forming the image of a material object consisting of the edge of the deflector, which is not sensitive to the complex form or the diffuse appearance of an arc. It is possible to make use of a D2S lamp. The light flux in the beam can reach 1500 lumens, with a lamp S of 3000 lumens.

It should be noted that if the elliptical reflector 1 includes a lower portion which is symmetrical with the upper portion with respect to the horizontal plane passing through the optical axis X-X, the downwardly directed light would be unable to be used correctly because it would be a source of rising rays at the output of the lens 4 and would cause dazzling.

For the lower reflector, it is possible to conceive an elliptical reflector which also has foci C1 and C2, but which is a body of revolution around the straight line 8, instead of a body of revolution about the optical axis X-X according to the invention. Such a solution would give little light actually directed on the road for the lower part of the module, and would present a problem whereby it would be difficult to incorporate the module with any reasonable style.

The arrangement provided by the invention enables a lower reflector to be provided which is more open, so enabling the light in the lower part to be recuperated better.

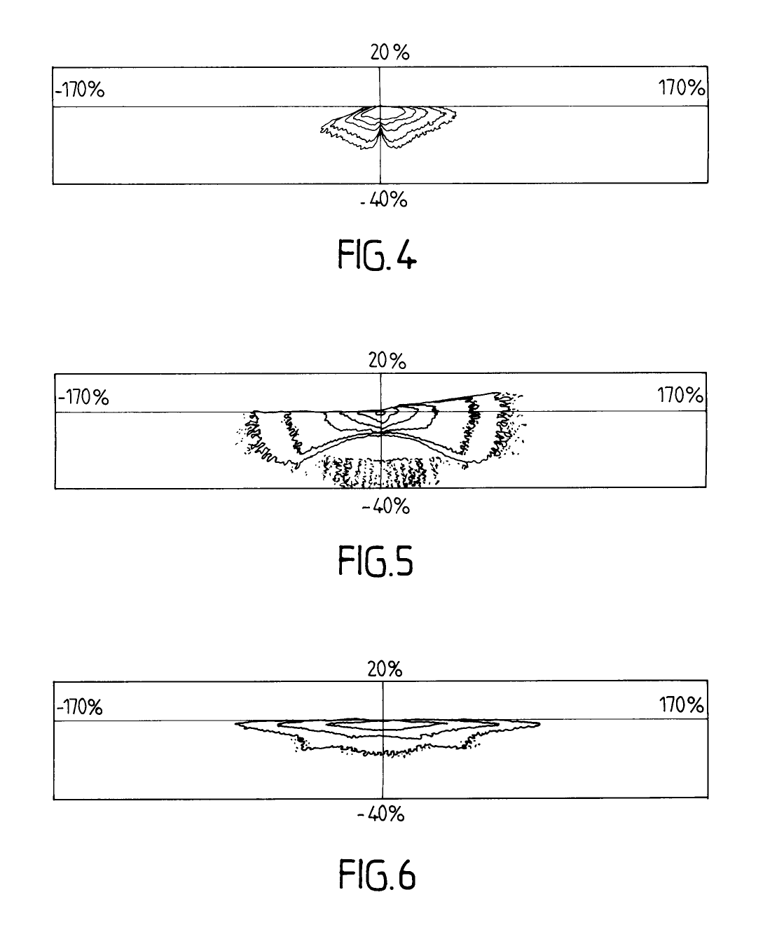

FIG. 4 of the drawings illustrates the pattern of isolux curves of the beam in the lower part (with a beam to be spread horizontally or at 15 degrees with ribs).

FIG. 5 shows the pattern of isolux curves for the beam which is produced by the upper part of the reflector (with the reflector used corresponding to a prior art design which is not adjusted for the deflector).

FIG. 6 shows the isolux pattern which is obtained with the lower portion of the reflector according to the invention, with the output face of the annular lens having been modified so as to spread the beam. The system corresponds exactly to that which gives the isolux pattern shown in FIG. 4.

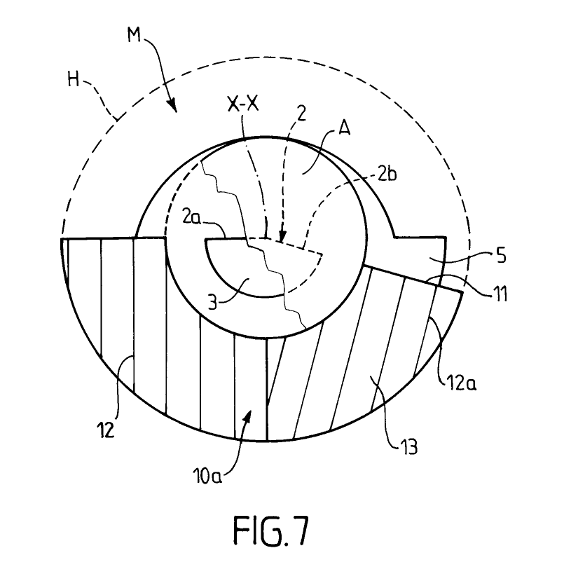

FIG. 7 is a modified version of FIG. 2. In FIG. 2 the ribs were all oriented vertically, but in this modified version, vertical ribs on the same side as the horizontal edge are associated with oblique ribs on the same side as the oblique edge. These oblique ribs are in practice substantially at right angles to the oblique edge which produces the 15 cut-off. A further modified version, not shown, consists in using only oblique ribs.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. An optical module of a headlight for a motor vehicle, for giving a cut-off beam, defining an optical axis and comprising at least the following:
either a first reflector and a light source, a cover piece, optionally a deflector, and a convergent lens;
or else a reflector with a complex surface associated with a light source, wherein said module further includes:
a second reflector which is situated below the horizontal plane that passes through the optical axis, said second reflector defining a meridian curve which comprises the following:
an elliptical arc;
and a curve situated in front of the end of the elliptical arc, the front end of this curve being coincident with the second focus of the said elliptical arc, or close to the said focus; and
together with a lens which surrounds at least one zone of the lower portion of the convergent lens, or, in the absence of any convergent lens, which surrounds the zone through which the rays pass in the plane of said lens,
a cross section of said lens, taken through a plane which giving two curves corresponding respectively to the input face and the output face of the lens, said curves themselves corresponding to the cross section of a convergent lens taken through a plane passing through its optical axis.

2. The optical module according to claim 1, wherein the second reflector is a body of revolution about the optical axis.

3. The optical module according to claim 1, wherein said meridian curve situated in front of the end of the elliptical arc is replaced by a straight segment parallel to the optical axis and situated in front of the end of the elliptical arc, a front end of said straight segment being coincident with the second focus of said elliptical arc, or close to said focus.

4. The optical module according to claim 1, wherein the lens which surrounds at least one zone of the lower portion of the convergent lens, or, in the absence of any convergent lens, surrounding the zone through which the rays pass in the plane of said lens, is annular, and in particular has the form of a sector of revolution about the optical axis.

5. The optical module according to claim 1, wherein it further includes the following:
a reflector of the elliptical type which is situated mainly above the horizontal plane that passes through the optical axis, having a first focus situated on the optical axis towards the base of the headlight, and a second focus which is situated further forward along the optical axis;
a deflector, the front edge of which passes through the second focus of the reflector or close thereto;
a light source situated at the first focus of the reflector or close to said focus, said light source emitting light both upwards and downwards; and
a convergent lens which is situated in front of the deflector and which defines a focus coincident with the second focus of the reflector, or close to said second focus.

6. The optical module for a headlight according to claim 1, wherein the light source is a xenon lamp.

7. The optical module according to claim 1, wherein the light source defines an axis which is coincident with the optical axis of the module.

8. The optical module according to claim 1, wherein the lens which surrounds at least one zone of the lower portion of the convergent lens, or, in the absence of any convergent lens, surrounding the zone through which the rays pass in the plane of said lens, has a flat face that faces outwards and a convex face that faces towards the reflector.

9. The optical module according to claim 1, wherein the outer face of the lens which surrounds at least one zone of the lower portion of the convergent lens, or, in the absence of any convergent lens, surrounds the zone through which the rays pass in the plane of said lens, has vertical and/or oblique ribs, for the purpose in particular of enabling the light beam to be spread.

10. The optical module according to claim 1, wherein the lens, a lens which surrounds at least one zone of the lower portion of the convergent lens, or, in the absence of any convergent lens, surrounds the zone through which the rays pass in the plane of said lens, is made of a plastics material.

11. The optical module according to claim 1, wherein the main/convergent lens is made of glass, and the lens which surrounds at least one zone of the lower portion of said convergent lens, is formed by being molded on the main lens, the assembly that comprises the main lens and the annular lens thereby constituting a single component.

12. The optical module according to claim 10, wherein the lens, a lens which surrounds at least one zone of the lower portion of the convergent lens, or, in the absence of any convergent lens, surrounds the zone through which the rays pass in the plane of said lens, comprises polysulphone or polycarbonate.

13. The optical module according to claim 1, wherein the assembly that consists of the first reflector and second reflector is made in injection cast metal.

14. An optical module for a motor vehicle for providing a low beam, said optical module comprising:
a plurality of reflectors;
at least one of said plurality of reflectors being situated below a plane that passes through an optical axis of said optical module, said at least one of said plurality of reflectors being adapted to define a meridian curve comprising:
an elliptical arc;
a curve situated in front of an end of said elliptical arc, a portion of said curve being generally coincident with a focus of said elliptical arc; and
at least one lens which generally surrounds at least a portion of a zone through which light rays from a light source may pass;
said at least one of said plurality of reflectors comprising a portion that extends generally along said optical axis and a second portion extending radially away from said optical axis.

15. The optical module as recited in claim 14 wherein said at least a portion of said second portion is generally inclined downward relative to a horizontal plane that passes through said optical axis.

16. The optical module according to claim 14, wherein at least one of said plurality of reflectors is a body of revolution about the optical axis

17. The optical module for a headlight according to claim 14, wherein the light source is a xenon lamp.

18. The optical module according to claim 14, wherein the light source defines an axis which is coincident with the optical axis of the module.

19. The optical module as recited in claim 14 wherein at least a portion of said at least one lens is made from a polysulphone or polycarbonate material.

20. The optical module as recited in claim 1 wherein said cut-off beam is a low-beam.

21. The optical module as recited in claim 1 wherein said first reflector is a reflector of the elliptical type.
